(19) United States
(12) Patent Application Publication
(10) Pub. No.: US 2003/0105854 A1
(43) Pub. Date: Jun. 5, 2003

(54) Method and system for controlling and coordinating devices and appliances, such as from a central portal and via a wide-area communications network

(76) Inventors: Vilhjalmur Thorsteinsson, Reykjavik (IS); Gudmundur Loeve, Reykjavik (IS); Gudjon Mar Gudjonsson, Reykjavik (IS); Arnar Sigurdsson, Seltjarnarnes (IS)

Correspondence Address: PERKINS COIE LLP, PATENT-SEA, P.O. BOX 1247, SEATTLE, WA, 98111-1247, US

(21) Appl. No.: 10/318,332

(22) Filed: Dec. 11, 2002

Related U.S. Application Data
(63) Continuation of application No. PCT/US01/21392, filed on Jul. 6, 2001.
(60) Provisional application No. 60/216,447, filed on Jul. 6, 2000.

(51) Int. Cl. G06F 7/00; G06F 15/173; G06F 15/16; G06F 17/30

(52) U.S. Cl. 709/223; 707/10; 709/203

(57) ABSTRACT

A central portal coordinates and controls devices at client sites based on, for example, predetermined times, or requests by users or service providers. The central portal includes one or more server computers that receive an event associated with a client site. The central portal identifies the client site from the received event and retrieves a record or other data associated with a client site. The central portal provides a command sequence based on the received event and the retrieved record, and provides, over a network, an executable command sequence to a device residing at the client site to control the device at the client site. The client site can include both private residences, commercial buildings, vehicles (cars, boats, etc.), etc. The central portal resolves any conflicts and performs any necessary data transformations.

### CROSS-REFERENCE TO PRIOR APPLICATION

This application is a continuation of PCT/US01/21392 filed Jul. 6, 2001, which claims priority to U.S. Provisional Application No. 60/216,447 filed Jul. 6, 2000, which are incorporated herein in their entireties.

### TECHNICAL FIELD

The present embodiments relate to a computer method and system for controlling and coordinating devices, appliances, and service providers.

### BACKGROUND AND SUMMARY

Historically, appliances and devices in the home have been more or less unconnected to and independent of each other. The exceptions to this rule have been limited, such as VCRs that can turn television sets on or off, or remote controls that control more than one device.

The last couple of years have seen acceleration in the development of residential or home networks, where appliances, devices, lighting and other fixtures are connected together for central control and coordination. As an example, a simple device control technology called X-10 has enjoyed a degree of mass-market popularity. It works by overlaying a high-frequency signal on a house's AC power line network, providing a simple means of addressing nodes on the electrical grid within the house to turn lights and appliances on and off and to provide dimming capability. Other, more robust house control schemes include CEBus, Instabus and LonWorks. These systems are usually programmable via a central device within the house itself. This controller device maintains a schedule of events to occur at predetermined points in time or intervals, and specifies how a particular event input (such as a switch being flipped) should trigger a sequence of event outputs (such as a set of lights being turned on). In some cases, a general-purpose computer is employed to execute this logic. The house network is in most cases self-contained, but some systems do allow homeowners to “log on” to their home control systems remotely to obtain status and even issue commands.

A number of initiatives have recently been started to make home network control technologies more powerful, flexible and applicable to the mass market. An important aspect is to have a standard way of exposing and accessing the “intelligence” of each device, allowing its status to be queried, commands to be issued to it and events to be received from it. Among initiatives in this direction are Sun Microsystems' Jini, the Open Systems Gateway Initiative (OSGi), and Universal Plug and Play (UPnP). These initiatives are all in their formative phase; for example the first version (V1.0) of the UPnP specification was released on Jun. 8, 2000.

These initiatives are centered on describing the local environment of the house network, where the control and coordination intelligence resides on a gateway device or computer within the house. In the case of OSGi, small control applications (“applets”) are assumed to be downloaded from an outside party into an OSGi gateway or controller, which subsequently controls each home network device. In the case of UPnP, so-called control points are specified, which communicate via an XML-based protocol with individual devices. UPnP v1.0 in general assumes that control points sit on the same local network (subnet) as the devices they control, although the UPnP framework can also be employed in a scenario where the control points are remote.

With the rapid adoption of Digital Subscriber Line (DSL), two-way cable modems, and wireless local loops (WLL), permanent, reliable “always on” Internet connections to the home are becoming commonplace. By combining Internet based communications and content with home network control, it is now becoming possible to deliver a new set of services and conveniences to the home.

With existing systems, a service provider who wants to offer services to homeowners through their home networks needs to connect its server computers to each home network. These networks are in the general case heterogeneous, i.e. they can be based on different device models and protocols. Homeowners must then maintain log-in accounts with a plurality of service providers to allow them to administer and manage their subscribed services. There is no simple way for the homeowner to see an overall schedule of events, assign priorities and authorization, etc. He or she also needs to configure the home network's Internet gateway to allow routing of control information to and from each service provider, or in other words, punch holes in the home's Internet firewall. Finally, a conflict situation can arise where one service provider, for instance an electrical utility, is commanding an air conditioning unit to turn off, while an HVAC provider is at the same time instructing it to turn on. Conflicts can also arise between service providers and human users.

Relevant information may be found at the following locations:

“Universal Plug and Play Device Architecture, version 1.0” http://www.upnp.org/UPnPDevice_Architecture_{—}1.0.htm Microsoft Corporation, Jun. 8, 2000

“e-services to the home: An unconquered frontier” http://www.ericsson.com/wireless/products/ebox/pdf/concept.pdf L. M. Ericsson AS, date unavailable

“OSGi Service Gateway Specification Release 1.0” http://www.osgi.org/about/spec1.html Open Services Gateway Initiative (OSGi), May 3, 2000

Jini™ Specifications v. 1.1 Beta http://www.sun.com/jini/jcp.pdf Sun Microsystems, May 2000

Intel's E-home Vision http://www.intel.com/internetappliances/webappliance/media/ehome.pdf Intel Corporation, April 2000

Microsoft Home Networking main page http://www.microsoft.com/homenet/default.htm Microsoft Corporation, date unavailable

Windows Millennium Edition, home networking http://www.microsoft.com/windowsME/guide/homenetworking/default.asp Microsoft Corporation, date unavailable

“Home Plug and Play Overview” http://www.cebus.org/ovrvw.htm CEBus Industry Council, Inc., date unavailable

“Echelon's LonWorks® Products” http://www.echelon.com/Products/technical/pdfs/manuals/databook1999A.p df Echelon Corporation, 1999 Edition Version A

X-10 Power line Communications Standard http://www.x10.org

### GLOSSARY OF SOME TERMS

In general, definitions of several terms used herein may be found at the following sites. Such definitions are further defined by the description of the invention as a whole (including the claims) and not simply by such definitions. Also, certain acronyms are defined below.

GENA, General Event Notification Architecture (http://www.upnp.org/draft-cohen-gena-client-01.txt)

HTML, Hypertext Markup Language (http://www.w3.org/TR/html401/)

HTTP, Hypertext Transfer Protocol (http://www.w3.org/Protocols/rfc2616/rfc2616.txt) IP, Internet Protocol (IETF RFC 791, http://www.isi.edu/ in-notes/rfc791.txt)

SOAP, Simple Object Access Protocol (http://search.ietf.org/internet-drafts/draft-box-http-soap-01.txt)

SQL, Structured Query Language (ISO/IEC 9075:1992, “Information Technology—Database Languages—SQL”)

TCP, Transmission Control Protocol (IETF RFC 793, http://www.isi.edu/ in-notes/rfc793.txt)

UDP, User Datagram Protocol (IETF RFC 768, http://www.isi.edu/ in-notes/rfc768.txt)

WAP, Wireless Application Protocol

WML, Wireless Markup Language

XML, Extensible Markup Language (http//www.wp3.org/TR/REC-xml)

Aspects of the present invention overcome the limitations of the prior art and provide additional benefits. A brief summary of some embodiments and aspects of the invention are first presented. Some simplifications and omissions may be made in the following summary; the summary is intended to highlight and introduce some aspects of the disclosed embodiments, but not to limit the scope of the invention. Thereafter, a detailed description of illustrated embodiments is presented, which will permit one skilled in the art to make and use aspects of the invention. One skilled in the art can obtain a full appreciation of all the aspects of the invention from the subsequent detailed description, read together with the figures.

Aspects of the present invention include a portal that connects on one side to devices and appliances within houses (typically homes or cottages), buildings (including multifamily dwellings and commercial buildings), boats and cars—collectively referred to as Client Sites—and on the other side to service providers and general content, in both cases via a wide-area network (typically the Internet). The portal allows homeowners to configure and control their home devices, appliances and services from one central point, via one log-in account, and allows service providers to offer their services in a standard way to a multitude of Client Sites without having to know or care about the details of each network implementation. The portal takes care of security, authorization, scheduling, prioritization, and conflict resolution. It links the outside world of content to the inside world of control. One example would be accessing weather forecasts or TV schedules from the Internet and using this information to open or close windows and program a VCR, or enabling electric utilities to offer “Energy Saver” service bundles that, in return for lower rates, allow the utility to modify thermostat settings or shut off or postpone particular energy-consuming tasks within the home—such as washing or drying—at times of peak electricity demand.

### BRIEF DESCRIPTION OF THE DRAWINGS

FIG. 1 shows an overview of an embodiment of the present invention, with its wide-area network connections.

FIG. 2 shows an overview of internal mechanisms of an embodiment of the present invention.

FIG. 3 shows how one embodiment of a central portal handles incoming events from Client Sites.

FIG. 4 shows how the central portal handles incoming commands from human users.

FIG. 5 shows how the central portal handles incoming requests from service providers.

FIG. 6 shows how the central portal handles events from the internal Scheduler mechanism.

FIG. 7 shows how the central portal handles queries from human users.

FIG. 8 illustrates an example of how the central portal handles an event from the internal Scheduler mechanism.

FIG. 9 illustrates an example of how the central portal handles an event coming in from a Client Site.

FIG. 10 illustrates an example of how the central portal handles a command from a human user.

FIG. 11 illustrates an example of how the central portal handles a request from a service provider.

FIG. 12 illustrates an example of how the central portal handles a query from a human user.

FIG. 13 is a flow diagram showing the processing logic of the Execution Engine mechanism.

FIG. 14 is a flow diagram showing the processing logic of the Authorization mechanism.

FIG. 15 is a flow diagram showing the processing logic of the locking and Conflict Resolution mechanism.

FIG. 16 is a block diagram of a suitable computer system for employing aspects of the invention.

Note: The headings provided herein are for convenience and do not affect the scope or interpretation of the invention.

### DETAILED DESCRIPTION

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

Aspects of the present invention are directed to a central portal for controlling and coordinating devices and appliances, via a wide-area communications network. The portal helps users, typically homeowners and their families, administer and maintain their devices and appliances. It also serves as a conduit and platform for bundled services provided by external service and content providers, who then do not need to connect their services to individual home networks. The security risk of opening up a home network for access by multiple service providers is greatly reduced with aspects of the present invention.

The central portal connects to Client Site devices and appliances either directly or indirectly (through an intermediary gateway device) via a wide-area network. At the same time, it connects to human users and service providers' systems over the same or different wide-area network.

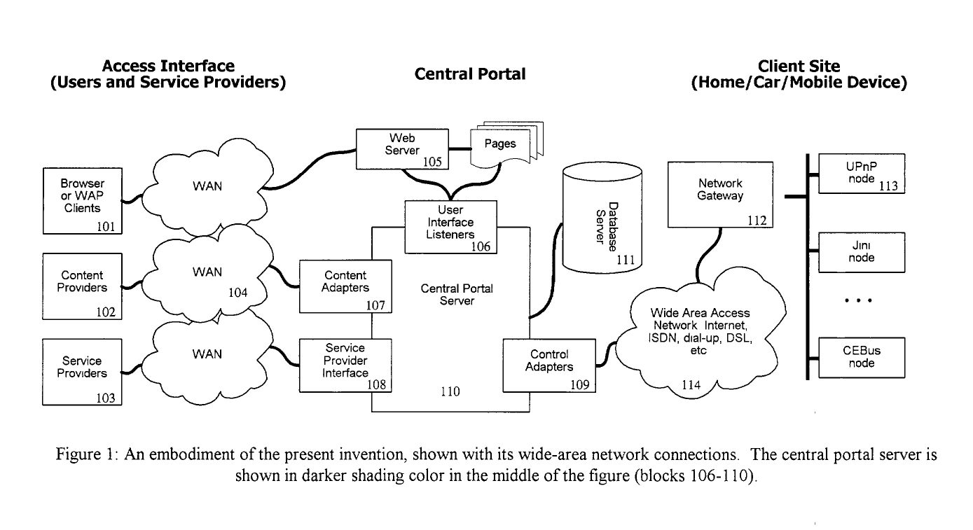

FIG. 1 shows an embodiment of the central portal server (blocks 106 to 110, inclusive). Over one or more wide-area networks (blocks 104 and 114), it receives: event notifications from a plurality of Client Sites (blocks 112 and 113) via “Control Adapters” (block 109), commands and queries from human users (block 101) via a Web Server (block 105) coupled to “User Interface Listeners” (block 106), content material from third party content sources (block 102) via “Content Adapters” (block 107), and requests from service providers (block 103) via “Service Provider Interfaces” (block 108).

A Client Site is shown on the right side of FIG. 1. Each Client Site typically has one or more devices and appliances (blocks 113 and below). They are either directly connected to a wide-area network (block 114), or connected indirectly through a gateway device (block 112). The central portal is able to communicate with each device through the wide area network. Through Control Adapters (block 109) it can obtain event notifications from the devices, and issue commands and queries to the devices. The portal does not require the devices to support events, commands or queries, but can use any or all of these capabilities if present.

In the middle of FIG. 1 is the central portal itself. It is linked to a data storage medium (block 111) that maintains information about registered users and Client Sites, as well as service providers, authorization information, event maps, scheduler configuration, and command sequences. It contains a Scheduling mechanism, which maintains a database of events to be triggered on behalf of Client Sites, either at particular intervals or at pre-configured points in time. In embodiments of this invention, the Scheduling mechanism may offer intervals ranging from milliseconds to days, weeks and months, and points in time related to time of day, time of week, time of month, holidays, birthdays, cultural events, etc.

To the left in FIG. 1 are the external clients, which include human users (block 101) and service providers' systems (block 103). They connect to the central portal via one or more WANs (block 104). Human users can log on to their accounts on the central portal, and view and administer devices and appliances at their associated Client Site or Sites. They can also view information about services being provided into their Client Site or Sites by service providers. In embodiments of this invention, the interaction protocol may be Hypertext Markup Language (HTML) over Hypertext Transfer Protocol (HTTP), Wireless Markup Language (WML) over Wireless Application Protocol (WAP), or any of a plurality of other interaction protocols.

Service providers link their systems to the central portal, using any of a plurality of communications protocols. In embodiments of this invention, these protocols may include Hypertext Transfer Protocol (HTTP) and Simple Object Access Protocol (SOAP). Through the communications link, they can issue queries and commands to the portal (block 108). These queries and commands may apply to single Client Sites or to sets of such sites. All command sequences are validated against the service provider's authorization settings for each Client Site before being issued to devices through the appropriate Control Adapter (block 109 of FIG. 1) in each case.

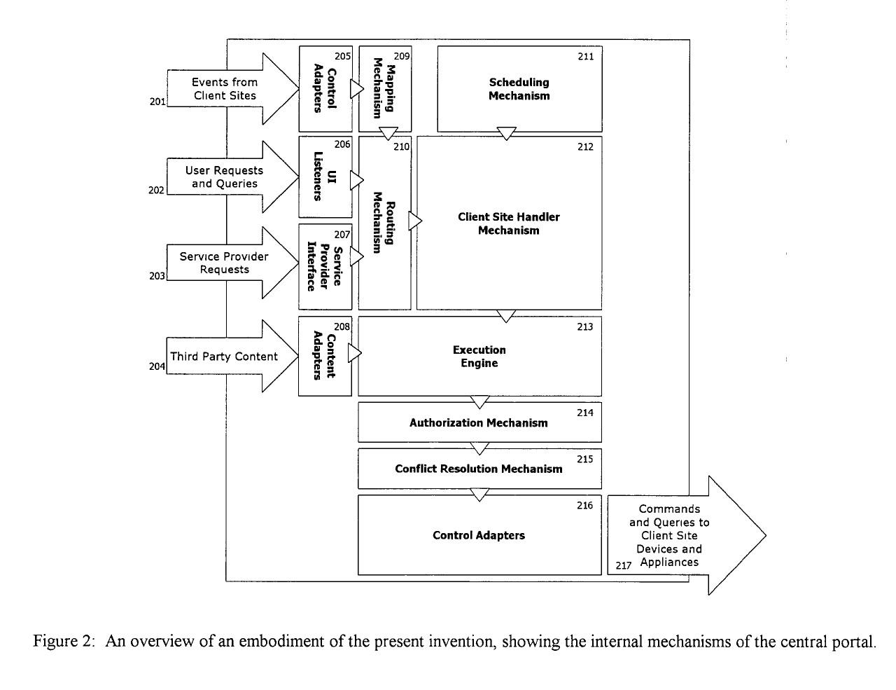

FIG. 2 shows the subsystems of the central portal server in more detail. The portal server contains a Scheduling mechanism (block 211 in FIG. 2), which maintains, for each Client Site, a set of events to be triggered at particular intervals or at specific points in time.

Event notifications (whether originating from the scheduler or from Client Sites), queries, requests and commands are routed to the appropriate Client Site handler mechanism (block 212 in FIG. 2) within the central portal. The Client Site handler associates a Client Site Context with the event, query, request or command. Incoming events from Client Sites (block 201), arriving via Control Adapters (block 205), are passed on to a Mapping mechanism (block 209), which retrieves a corresponding (previously configured) sequence of commands from the portal's data store.

Commands and command sequences may refer to external variables, such as the time of day, or the state of devices at the Client Site, or information extracted from content publishers on the wide-area network, such as weather forecasts or television schedules.

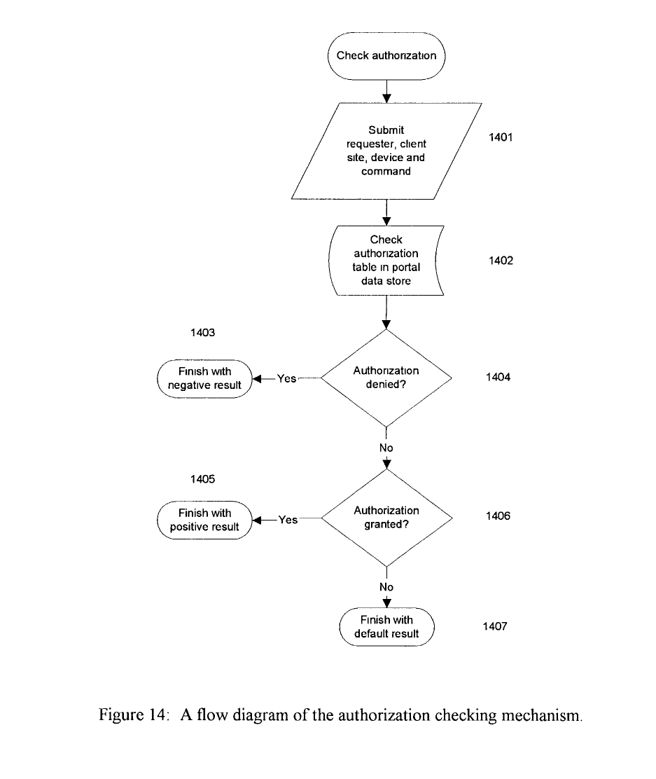

Before queries or commands are issued to the Client Site, they are validated against the authorization permissions of the requesting agent (human user, anonymous user or service provider) by the Authorization mechanism (block 214 in FIG. 2; see also FIG. 14). For a query or command to be issued to a Client Site, the requesting party must have been previously authorized to invoke the command or query. Authorization information is stored in the portal's data store and can be entered and edited by users. Embodiments of this invention may allow only particular users to modify authorization settings, for instance a specially appointed user within each family.

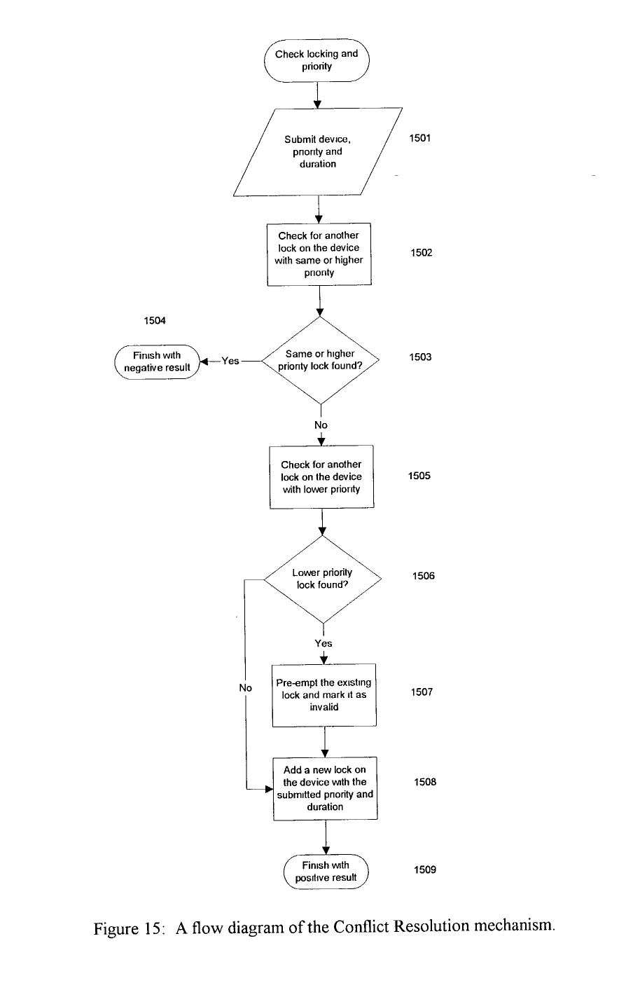

After successful authorization, but before a command is issued to a device at a Client Site, a Conflict Resolution mechanism (block 215 in FIG. 2; see also FIG. 15) checks whether a lock on the device is held by another requesting agent, having the same or higher priority as the current requesting agent. If such a lock exists, the command is not issued to the device, thereby avoiding a resource conflict.

Control Adapters are the final step on the portal's output side (block 216 in FIG. 2). They translate generic, protocol-neutral commands and queries to device and network specific control and query packets that are appropriate for the particular Client Site being addressed (block 217). The central portal can host a plurality of Control Adapters, one for each device control standard or proprietary protocol. In embodiments of this invention, there may be Control Adapters for Universal Plug and Play (UPnP), OSGi, and Jini protocols, over TCP/IP, UDP/IP or other WAN networking standards, using dial-up or always-on connections.

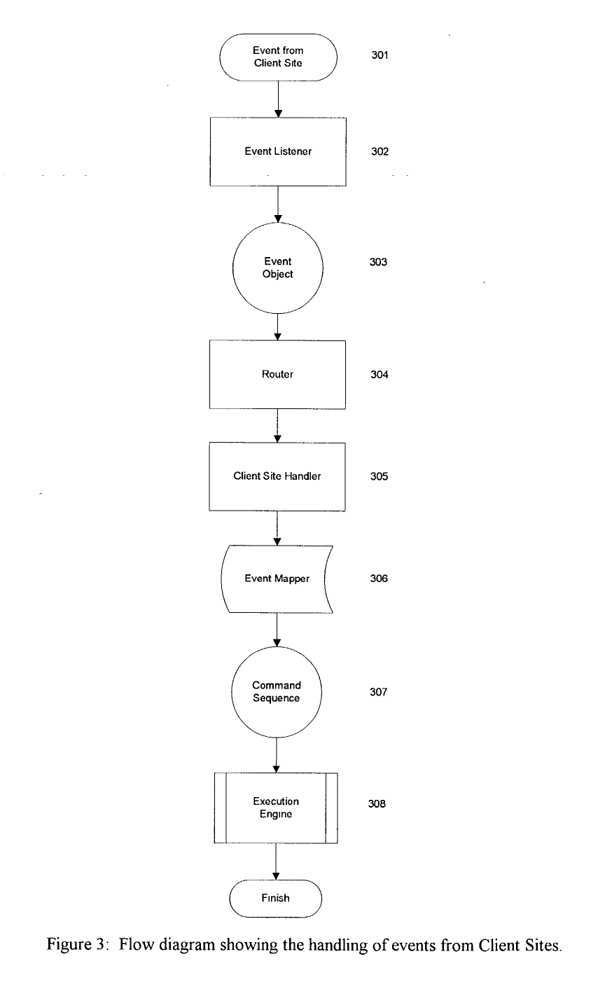

FIG. 3 shows how an embodiment of this invention handles incoming events from a Client Site. These events are assumed to arrive over the wide-area network (block 104 of FIG. 1) to the central portal. The portal has a Listening mechanism (block 302 of FIG. 3), which in one embodiment may be implemented using the TCP/IP and/or UDP/IP network protocols to support such eventing standards as GENA (used by UPnP) and Jini/Java RMI. Once an event from a Client Site has been received into the portal and decoded from its originating protocol into a generic internal object format (block 303) by an appropriate Control Adapter, it is relayed to the Router mechanism (block 304). The internal object format contains information about the origin of the event, the time and date of the event, the event type, and optional parameters. Embodiments of this invention may decode and process further information about events. Embodiments of this invention may use XML, text, binary or other internal object representations for events, as will be apparent to those skilled in the art.

Using data from the event object, the event router discovers from which Client Site the event originated, validates that this is a known (registered) Client Site by consulting the portal's data store, and forwards the event into the Client Site handler mechanism (block 305). In one embodiment of this invention, the IP address of the originator of the event notification message is used to identify the Client Site. Alternate embodiments may require the Client Site gateway to identify itself and establish a session with the central portal, using a password or other authentication, before posting event notification messages. Other substantially equivalent means of Client Site identification will be apparent to those skilled in the art.

In embodiments of this invention, the Client Site handler mechanism may execute on the same computer as the Listening and Router mechanisms, or on different computers. Embodiments of this invention that use multiple computers will generally allow for a larger number of Client Sites to be served simultaneously by the central portal.

The Client Site handler associates a Client Site Context with the incoming event, retrieving information about the Client Site from the portal's data store. This information includes data about devices known to be present at the Client Site. It then looks up a command sequence associated with the particular event type via the Mapping mechanism (block 306). In one embodiment of this invention, the event type identifier is used as an index into a table of command sequences in the portal's data store. Multiple types of events may map to the same command sequence.

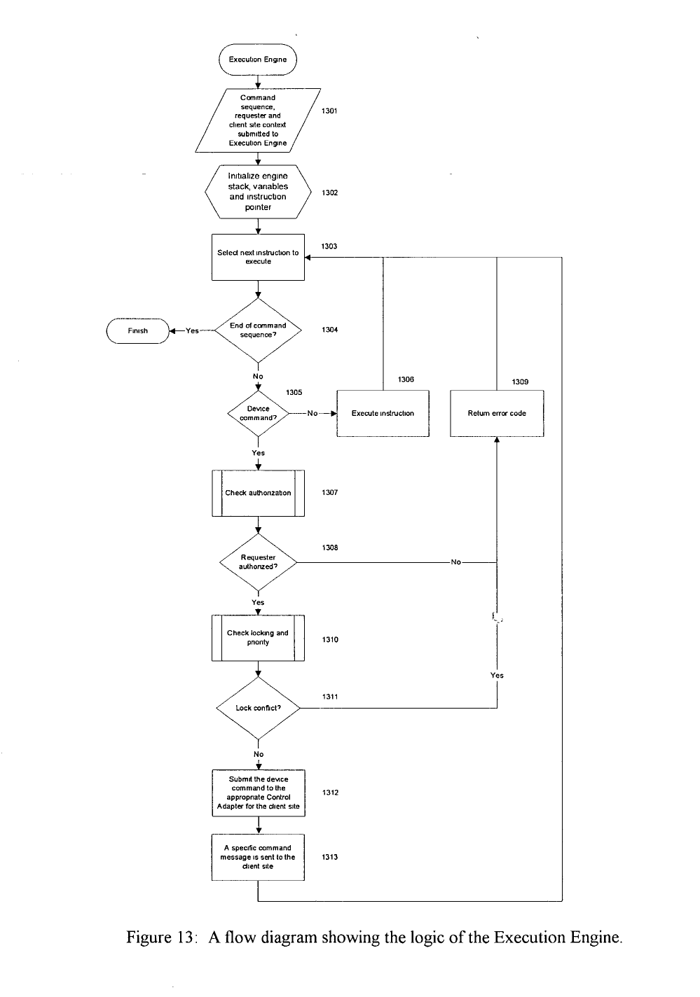

The resulting command sequence (block 307) is passed on to an Execution Engine (block 308, invoking the mechanism of FIG. 13), which checks and executes the commands as detailed below.

One embodiment of a mechanism for executing commands is shown in FIG. 13. In embodiments of this invention, command sequences can be executed using an instruction pointer, run-time stack, variable store and other mechanisms familiar to those skilled in the art. Embodiments of this invention may use well known scripting engines to execute commands, such as VBScript, JavaScript or Tcl, or other known methods. However, regardless of the particular engine implementation, whenever a command sequence calls for a command to be sent to a device (block 1305 in FIG. 13), the Execution Engine will route it first through an Authorization mechanism (FIG. 14) and a Conflict Resolution mechanism (FIG. 15), and then—if authorized and not in conflict—to a Control Adapter (block 1312) appropriate for the Client Site, for final translation and transport to the particular device.

One embodiment of the Authorization mechanism is shown in FIG. 14. It checks whether a device command or query that is about to be issued is allowed to be initiated (block 1402 of FIG. 14) by the requesting user, or in the case of event responses, by an “Anonymous” user. If the command is not found to be authorized (blocks 1403 to 1407 of FIG. 14), it is rejected and an error indication is returned to the Execution Engine (block 1309 of FIG. 13).

The authorization check is performed by consulting the portal's data store, as shown in block of 1402 of FIG. 14. In one embodiment of this invention, a database table of authorizations is consulted, where the tuple (Client Site, user, device, command) is mapped to a result which is one of the values {allowed, forbidden, not specified}. In the case of an incoming event from a Client Site, then if the result of the Authorization check for user “Anonymous” is forbidden, the command is rejected. Other approaches to authorization checking can be taken in alternative embodiments, within the spirit of the invention. Embodiments of this invention may allow authorizations to be assigned to groups of users, and if an authorization result is not specified for a user, the privileges of any group or groups to which the user belongs will be considered.

One embodiment of the Conflict Resolution mechanism is shown in FIG. 15. Within command sequences, commands may be addressed to devices directly, or indirectly through a lock object. In the direct addressing case, the command sequence will contain a reference to the device being addressed, the identifier of a command and an optional parameter list. In embodiments of this invention using scripting engines such as JavaScript, such a command invocation could be expressed as “DeviceName.CommandName(parameter1, parameter2 . . . );”. Other substantially equivalent syntax can be supported by embodiments of this invention, as will be apparent to those skilled in the art. The device name is looked up by the Execution Engine within the Client Site Context, which is built by obtaining information from the portal's data store about all known devices at the Client Site. The device data store is populated either through the automatic device discovery supported by some common control protocols (for instance UPnP and OSGi), or by having users manually enter information about devices at their Client Site or Sites, from the portal's user interface.

Commands that are indirectly addressed to devices are invoked through intermediate lock objects. In this case, the command sequence contains a reference to a device being addressed and an instruction to request a lock on that device with a particular priority and duration. In embodiments of this invention using scripting engines such as JavaScript, such an instruction could be expressed as “LockObject=DeviceName.RequestLock(priority, duration);” where LockObject denotes the name of an appropriate variable. If successful, the lock request instruction returns a lock object, which can subsequently be used within the command sequence to invoke commands on the device in lieu of the device object itself. In embodiments of this invention using scripting engines such as JavaScript, such an invocation instruction could be expressed as “LockObject.CommandName(parameter1, parameter2 . . . );”.

Lock objects are only valid for the amount of time specified during their creation. Embodiments of this invention may allow a default validity to be implicitly applied if no validity period is explicitly specified. Similarly, the time unit of duration can vary between embodiments of this invention, ranging from small (for instance milliseconds) to large (for instance minutes). Embodiments of this invention may use a fixed time unit only or allow the specification of one of a set of time units in each case. After the validity period expires, the lock object can no longer be used to invoke commands. If this is attempted, an error code is returned to the Execution Engine and the command is not invoked.

Requests for lock objects fail (block 1504 of FIG. 15), returning an error code to the Execution Engine, if there already exists a valid (non-expired) lock object for the same device having the same or higher priority (block 1503). Embodiments of this invention may encode priorities as integer numbers where a higher number denotes a higher priority, or use other substantially equivalent encoding methods, as will be apparent to those skilled in the art.

If a request for a lock object has a higher priority than that of an existing lock object holder (block 1506 of FIG. 15), the requester with the higher priority is granted the lock (block 1508), while the existing lock is forcibly released and marked as invalid (expired) (block 1507). Subsequent commands addressed to the invalid lock object will return an error code to the Execution Engine, and the commands will not be invoked.

Direct invocations of commands, without the use of intermediary lock objects, can be construed as being equivalent to an invocation with a lock object of the lowest priority and a duration equal to the time it takes to invoke the command. Embodiments of this invention may disallow direct invocations of commands in favor of indirect locking only, with substantially the same result.

Embodiments of this invention may use a fixed duration for all locks, although this would be a less flexible implementation.

Embodiments of this invention may use a fixed priority for all locks, although this would be a less flexible implementation.

The effect of the Conflict Resolution mechanism is to ensure that conflicts between requests for the same resource (device) can be resolved based on priority and a first-come, first-served basis. Without the Conflict Resolution mechanism, conflicts may result when multiple human users, service providers and event handlers attempt to manipulate the same device or devices simultaneously. The Conflict Resolution mechanism also allows higher-priority services, such as fire or burglar alarms, to seize control of the resources they need, even when lower-priority services are already using those resources.

In embodiments of this invention, command sequences can access variables whose values are assigned at execution time by the Execution Engine. These variables can contain such information as the time of day and information obtained from third party content sources on the wide-area network, via Content Adapters (block 107 in FIG. 1 and block 208 in FIG. 2). Such information may be collected from the Internet, with examples being weather forecasts or television schedules.

Command sequences may contain commands that are not sent to the Client Site, but instead executed directly by the Execution Engine on the portal itself (block 1306 in FIG. 13). In embodiments of this invention, such commands could for instance send electronic mail to outside parties or update state variables that are maintained by the central portal on a data storage medium for each Client Site.

Command sequences can contain control structures familiar to those skilled in the art, such as while-loops, if-statements, switch/case constructs, block statements, procedure calls, nesting and recursion. The Execution Engine handles these control structures, maintaining an instruction pointer and a stack and data store for variables at run-time, as will be recognized by those skilled in the art.

Commands are issued to devices at Client Sites through an appropriate Control Adapter (block 109 in FIG. 1 and block 216 in FIG. 2) for each site. Embodiments of this invention may include Control Adapters for common control protocols such as UPnP, OSGi, Jini, and/or LonWorks. Control Adapters accept requests to issue a particular command or query to a certain device at a Client Site. Embodiments of the present invention may select the Control Adapter to use in each case by a look-up in the portal's data store, where the (Client Site, device) tuple is mapped to a particular Control Adapter.

The Control Adapter is asked to issue a command by passing to it an identifier of the device in question, the command to be issued, and any parameters required by the command. The Control Adapter translates these data into the appropriate command message for its associated protocol and relays it to the receiving device. In an embodiment of this invention, a Control Adapter for UPnP would for example generate an XML document containing a SOAP request that is relayed to the device using the HTTP protocol over TCP/IP.

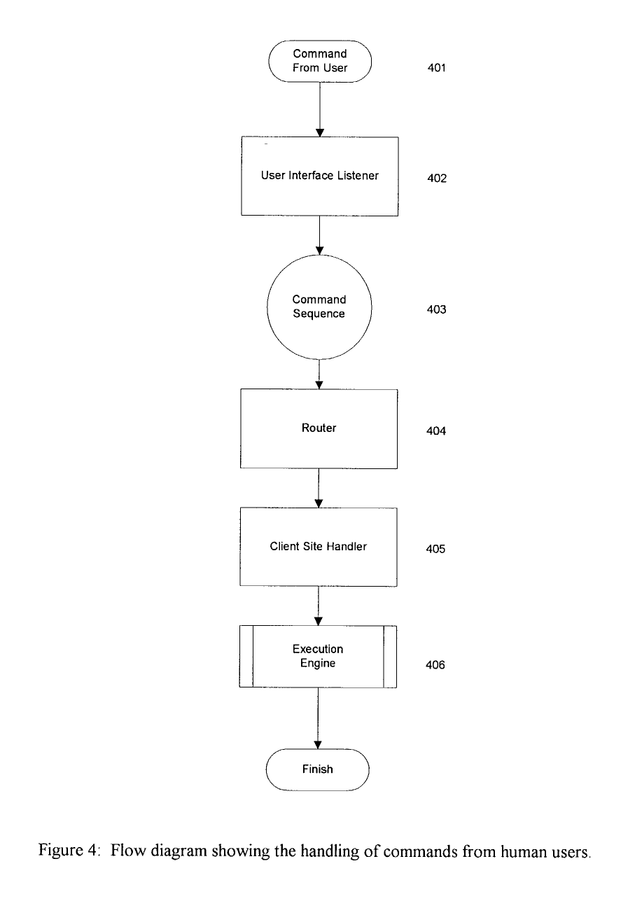

FIG. 4 shows how an embodiment of this invention handles commands arriving from the human users of the central portal. These commands are submitted via a user interface device (client) (block 101 of FIG. 1) that may be located within the Client Site or elsewhere, but is connected over a wide area network (block 104 of FIG. 1) to the central portal. Such user interaction has an implicitly associated human user, who must have explicitly authenticated himself or herself to the system in some way. Users must be recognized by the system as valid and registered. This is done by validating their information against data stored by the portal's central data storage mechanism, originally collected in the user and Client Site registration and configuration process.

In embodiments of this invention, user authentication may occur by entering a user identifier and a password on a keyboard, or by using other methods of authentication—for instance biometrics (fingerprint, iris scanning, etc.).

Embodiments of this invention may use HTML over the HTTP (World Wide Web) protocol to implement a user interface, or WML over WAP, although the invention is not limited to these languages or protocols.

The portal has a User Interface Listener mechanism, shown in FIG. 4, which in one embodiment may be implemented using the HTTP network protocol. Once a command from a user has been received into the portal (blocks 402 and 403 of FIG. 4), it is relayed to the Routing mechanism (block 404). In some embodiments, the User Interface Listener may perform some translation on the command before relaying it to the Routing mechanism. This would allow for flexibility in the requirements placed on the user, though it will be recognized by one of ordinary skill in the art that this is not required.

The entered command may implicitly refer to a particular Client Site, or it may be associated by default by the Routing mechanism. In the latter case, the router retrieves information about the submitting user from the portal's data storage medium, and extracts the associated default Client Site from the user's record.

Embodiments of this invention may allow a user to be associated with multiple Client Sites, for instance a house, car and cottage. In this case, commands and queries arriving from users must contain distinguishing information to enable the Routing mechanism to infer to which Client Site the command or query applies.

After association with a Client Site, the user command is forwarded into the Client Site handler mechanism (block 405). The Client Site handler associates a Client Site Context with the command, retrieving information about the Client Site from the portal's data store. The command is then submitted to the Execution Engine (block 406, invoking the mechanism of FIG. 13), where it is processed in the same manner as for incoming events. This includes filtering by the Authorization mechanism (block 1307 of FIG. 13, invoking the mechanism of FIG. 14) to see if the command is allowed to be executed by the requesting user. If authorized, the command is passed to the Conflict Resolution mechanism (block 1310 of FIG. 13, invoking the mechanism of FIG. 15). Otherwise—that is, if the requesting user is not authorized to invoke the command—execution is rejected and an error code is returned to the Execution Engine (block 1309). The Conflict Resolution mechanism checks whether the command is in conflict with an existing lock on the device in question. If not, it is passed on to the Client Site through a Control Adapter (block 1312). Otherwise, if a conflict has occurred, execution is rejected and an error code is returned to the Execution Engine (block 1309).

The comments about command sequences made in relation to the event handling flowchart in FIG. 3 also apply in this case, with the exception that the authorization check is performed for the requesting user, not an “Anonymous” user.

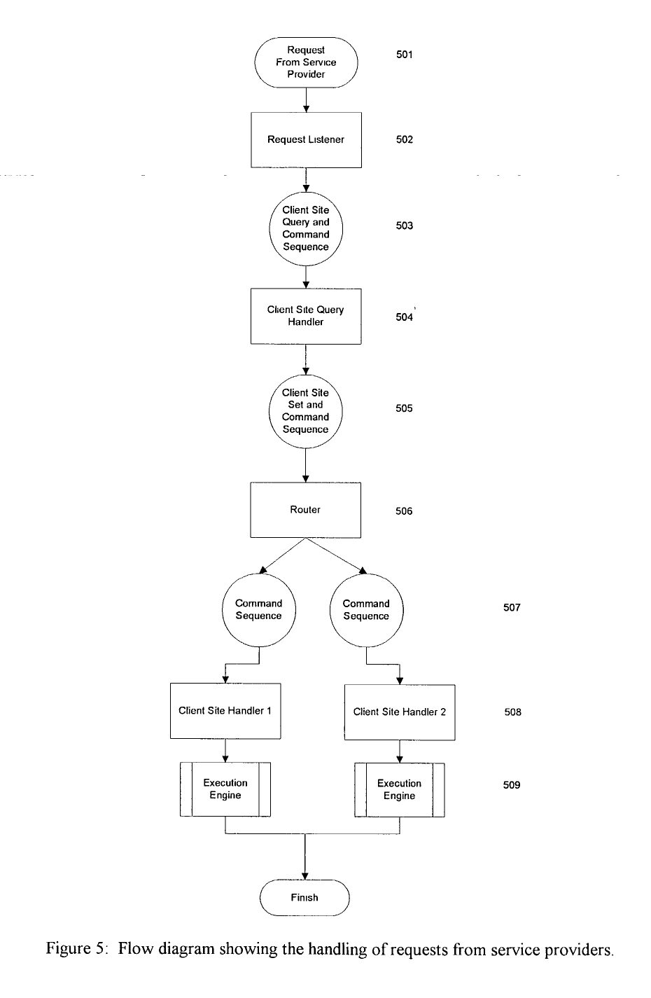

FIG. 5 shows how an embodiment of this invention handles requests arriving from service providers over a wide area network. Service providers must be recognized by the system as being valid and registered. This is done by establishing authenticated sessions with them. In one embodiment of this invention, such sessions might use the HTTPS (SSL) protocol over the World Wide Web.

The portal has a service provider Request Listening mechanism (block 502 of FIG. 5), which in one embodiment may be implemented using the SOAP request protocol over HTTP. Once a request from a service provider has been received into the portal, it is relayed to a Client Site query handler (block 504). The Client Site query handler extracts information from the request about the Client Site or set of sites to which the request is addressed. In embodiments of this invention, a request may specify a single Client Site, a particular set of Client Sites, all Client Sites that have an account with the originating service provider, or any combination of the above. One embodiment of the invention may allow specification of an inclusion and exclusion set of Client Sites, where the result set comprises all sites that are present in the inclusion set but not in the exclusion set. Other Client Site selection criteria may be employed in embodiments of this invention. As will be recognized by those skilled in the art, the Client Site selection criteria can be expressed using Structured Query Language (SQL) or other substantially equivalent syntax.

After the set of affected Client Sites has been determined (block 505), the service provider's command sequence is extracted from the request by the request router (block 506) and forwarded to the Client Site handler mechanism for each site (block 508). In embodiments of this invention, the command sequence can be represented as script text in a scripting language such as JavaScript, VBScript or Tcl, or as an XML document containing processing instructions, or in other effectively equivalent forms, as will be apparent to those skilled in the art. For each target site, the Client Site handler (block 508) associates a Client Site Context with the command sequence, retrieving information about the Client Site from the portal's data store.

The command sequence is then relayed to an Execution Engine (block 509, invoking the mechanism of FIG. 13), which executes each command in turn, as described for the event handling case. All commands to devices are checked individually by the Authorization mechanism to see whether they are allowed to be executed on behalf of the requesting service provider (block 1308 of FIG. 13, invoking the mechanism of FIG. 14). Unauthorized commands are rejected and an error code is returned to the Execution Engine (block 1309 of FIG. 13). All commands are also filtered by the Conflict Resolution mechanism of FIG. 15, as described for the event handling case.

The comments about command sequences made in relation to the event handling flowchart in FIG. 3 also apply in this case and the other cases discussed herein.

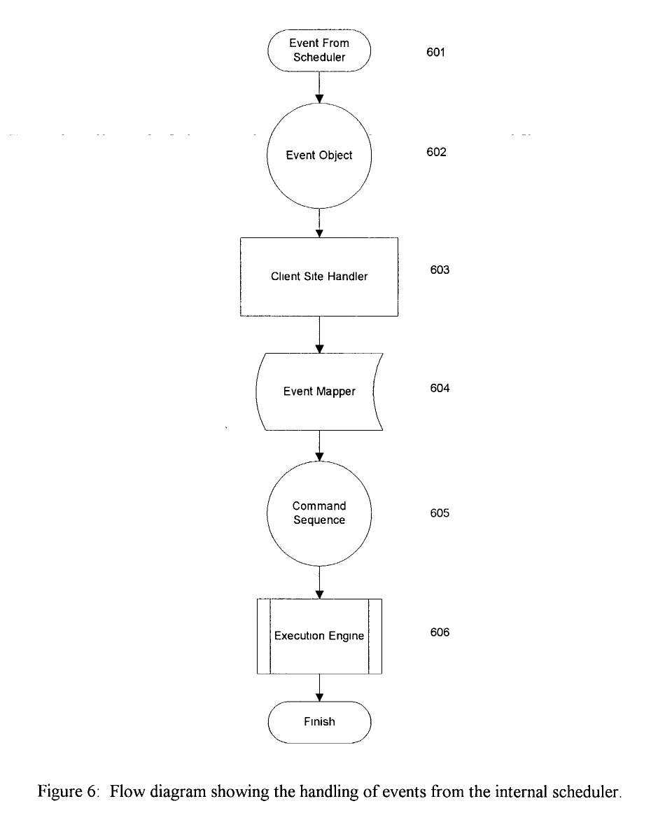

FIG. 6 shows how an embodiment of the present invention handles time events generated by the central portal's scheduling subsystem. Every Client Site has a corresponding Scheduling mechanism within the central portal. In embodiments of this invention, the Scheduling mechanism can be configured to generate events at fixed intervals (every ten seconds, every 24 hours, etc.) or using more advanced rules (at 8 am on the first Sunday of each month, on the Monday after Easter at noon, etc.). As will be recognized by those skilled in the art, the Scheduling mechanism can be implemented using a number of well-known techniques, one of which involves a scheduling thread that waits in an idle loop or in an operating system “sleep” call until the next event is due to occur, triggers the event, and then calculates the waiting time until the subsequent event before entering the wait loop again. In this embodiment, external changes to the list of scheduled events cause the Scheduling mechanism to break out of its wait and calculate a new waiting time for the next event.

Scheduler events for each Client Site are converted to event objects (block 602 of FIG. 6) and forwarded to the Client Site handler mechanism (block 603 of FIG. 6) as they are generated. The Client Site handler associates a Client Site Context with the event, retrieving information about the Client Site from the portal's data store. It looks up a command sequence associated with the particular event via the Mapping mechanism (block 604). Multiple types of events may map to the same command sequence. The resulting sequence (block 605) is passed on to the Execution Engine (block 606, invoking the mechanism of FIG. 13), which issues the commands to the Client Site in question through a Control Adapter (block 1312 of FIG. 13) after authorization checking for an “Anonymous” user (block 1307 of FIG. 13) as well as conflict checking (block 1310 of FIG. 13).

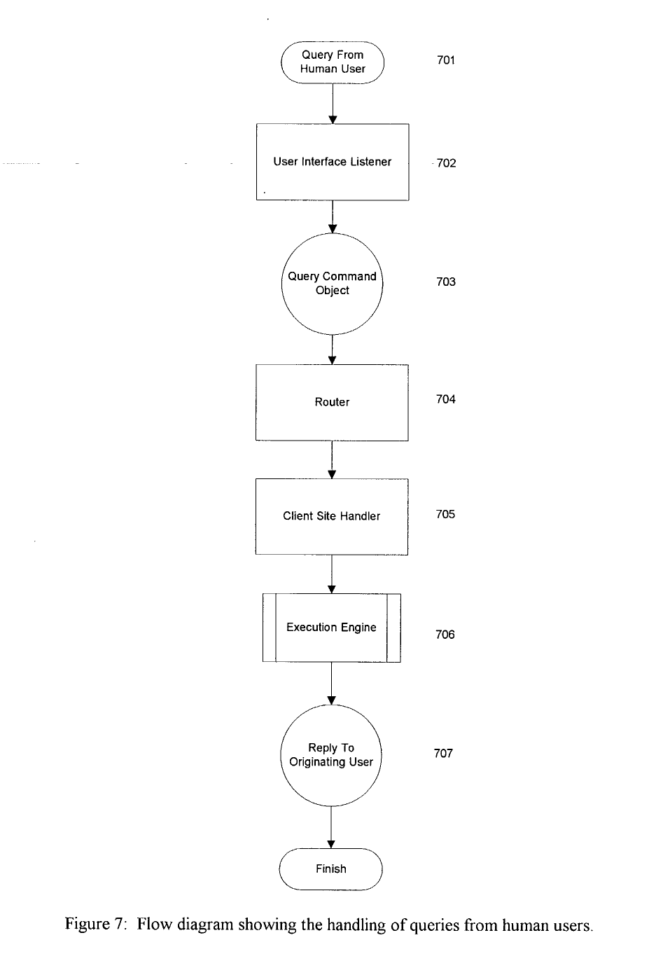

FIG. 7 shows how an embodiment of the present invention handles queries arriving from human users into the central portal. These queries are submitted from user interface devices that may be located within the Client Site or elsewhere, but are connected over a wide area network to the central portal. Such interaction has an implicitly associated human user, who has authenticated himself or herself to the system in some way, as described in the explanation for FIG. 4.

The portal has a User Interface Listener mechanism (block 702 of FIG. 7), which in one embodiment may be implemented using the HTTP network protocol. Once a query has been received into the portal, a query command object is created (block 703) and relayed to the Routing mechanism (block 704). The creation of this object may include some translation, as was discussed in the description of FIG. 4. The Routing mechanism discovers the Client Site with which the query is associated by retrieving information about the submitting user from the portal's data storage medium, and extracting the associated Client Site from the user's record. The comments accompanying FIG. 4 about association of users with Client Sites also apply in this case.

The query command object is then forwarded into the Client Site handler mechanism (block 705). The Client Site handler associates a Client Site Context with the query, retrieving information about the Client Site from the portal's data store. The query is filtered by the Authorization mechanism within the Execution Engine (block 706, invoking the mechanism of FIG. 13) to see if it is allowed to be executed by the requesting user (block 1307 of FIG. 13). It is also filtered by the Conflict Resolution mechanism (block 1310 of FIG. 13) to see whether a conflict could occur. Given that the result of both checks is positive, the Execution Engine executes the query and returns a result, which is delivered back to the originating user over a wide-area network (block 707 of FIG. 7). (In one embodiment of this invention, such a reply might be sent as text embedded within a HTML page, using the HTTP protocol over the World Wide Web.) If the query is not authorized, or if it is in conflict with existing device locks, it is cancelled and an error response is returned to the requesting user (block 1309 of FIG. 13). The execution of a query may require querying of Client Site devices, through Control Adapters (blocks 1312 and 1313).

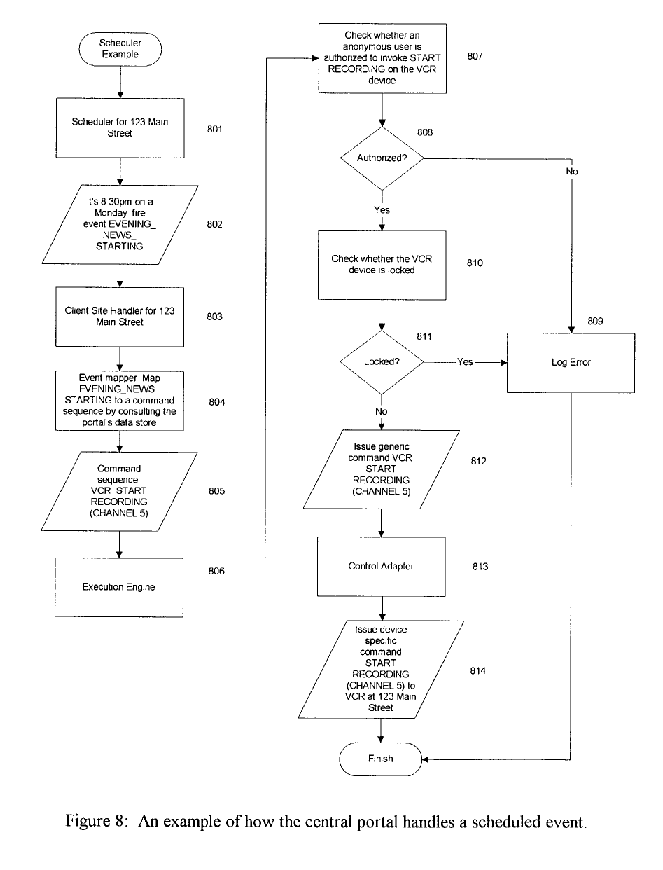

FIG. 8 shows an example of a scheduled event being generated and routed through one embodiment of the present invention. In the example, the scheduler for the site at 123 Main Street (block 801) has been configured to trigger an event every Monday at 8:30 pm. The event is identified as EVENING_NEWS_STARTING (block 802). The event is forwarded to the Client Site handler for 123 Main Street (block 803) where it is mapped to a command sequence by consulting the previously stored configuration for the site within the portal's data store (block 804). In this case, the resulting command sequence consists of a single generic command to a VCR device, START_RECORDING, with CHANNEL_{—}5 as a parameter (block 805). This command sequence is relayed to the Execution Engine (block 806), which checks whether an anonymous user is authorized to invoke the START_RECORDING command on the VCR device at 123 Main Street (block 807). If the command is authorized, it proceeds to a conflict check (blocks 810 and 811) that checks whether a lock exists on the VCR device. If no such lock exists, the Execution Engine issues the command through a Control Adapter (blocks 812-814) to the actual VCR device at 123 Main Street over a wide-area network. The Control Adapter translates the generic command to the specific command required for the VCR at the Client Site. If the command is not authorized, or if a lock conflict is detected, embodiments of this invention can log the failure in a data store (block 809) or report it to a system administrator by other means.

In embodiments of this invention, the representation of event identifiers and commands may vary. Events may be represented as strings of characters, with unique numeric identifiers or by other means. Commands may be represented using textual scripts, semi-compiled pseudo-code or fully compiled object code. Such modification within the spirit of the invention will be apparent to those skilled in the art, and does not affect the overall function of the router, the event mapper, the Execution Engine or other subsystems or mechanisms.

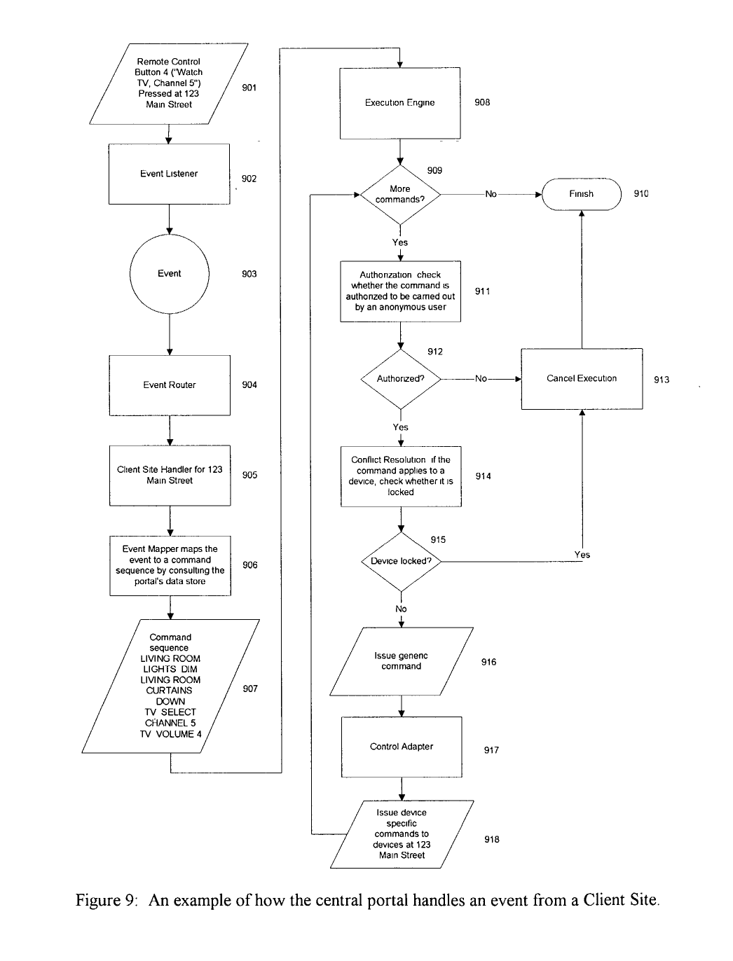

FIG. 9 shows an example of how one embodiment of the present invention handles an event from a Client Site. In this example, an event from a handheld remote control device is detected at the Client Site and routed over the wide area network to the central portal (block 901). (The remote control device might operate using infrared light or radio waves, which are detected by a gateway device on the local home network.) The Event Listening mechanism within the portal receives the event (block 902). The Listening mechanism creates an internal representation of the event (block 903) and marks it with a time stamp and identification of the event origin. The event is then relayed by the Router mechanism (block 904) to the Client Site handler for 123 Main Street (block 905) where it is mapped to a generic command sequence by consulting the previously stored configuration for the site within the portal's data store (block 906). In this case, the resulting command sequence consists of a series of commands to prepare the home for viewing of television channel 5 in the living room (block 907). The commands dim the lights in the living room, draw the curtains, turn on the television set, tune it to channel 5, and set the sound volume to level 4. This command sequence is relayed to the Execution Engine (block 908), which executes each command in turn. Before being executed, each command is checked to see if it is authorized to be invoked by an anonymous user (block 911). In this case, the portal does not know who is originating the event, and some operations may only be authorized if they are initiated by a known user having the correct set of privileges. If authorized, the commands are subjected to a conflict check (block 914) that checks whether locks exist on the device being addressed. If no such locks exist, the commands are finally issued through a Control Adapter (blocks 916 and 917) to the participating devices at 123 Main Street over a wide-area network (block 918). Again, the Control Adapter translates from generic commands to device-specific commands appropriate for the house network at 123 Main Street.

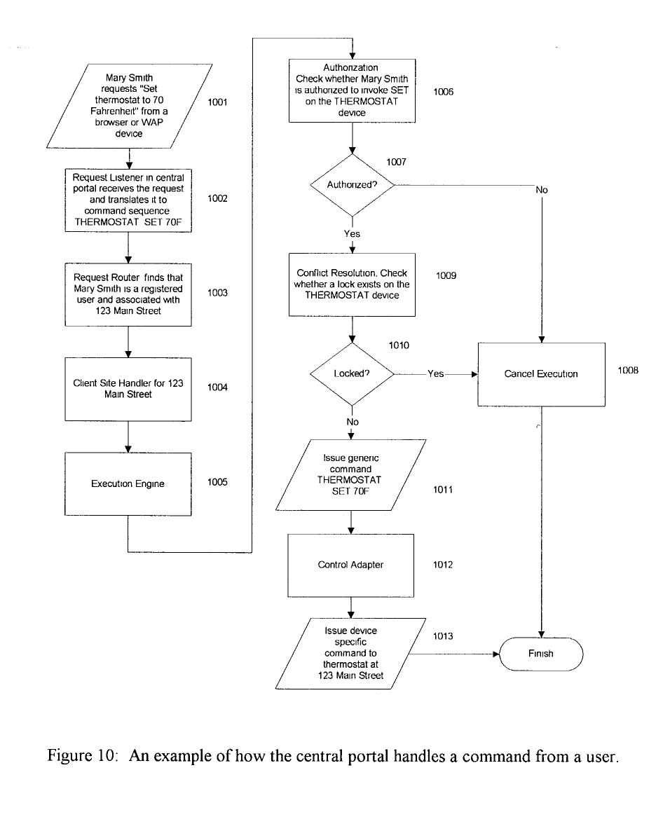

FIG. 10 shows an example of how an embodiment of the present invention handles a command from a human user. In the example, Mary Smith is requesting the portal to set the thermostat at 123 Main Street to 70 degrees Fahrenheit (block 1001). A User Interface Listener within the portal receives the command (block 1002). Similarly to the discussion of FIG. 4 above, the command from the user may be translated at this step before it is passed on. It is then relayed through the Routing mechanism (block 1003) to the Client Site handler for 123 Main Street (block 1004), since Mary Smith is registered as a user for that site. The Client Site handler associates a Client Site Context with the command and passes it to the Execution Engine (block 1005). The Authorization mechanism (block 1006) then checks whether the command can be executed by Mary Smith. Assuming that Mary is allowed to modify thermostat settings, the next step is a conflict check (block 1009) to see whether a lock exists on the thermostat device. If there is no conflict, the command is finally passed through a Control Adapter (blocks 1011 and 1012) to the thermostat at 123 Main Street over a wide-area network (block 1013).

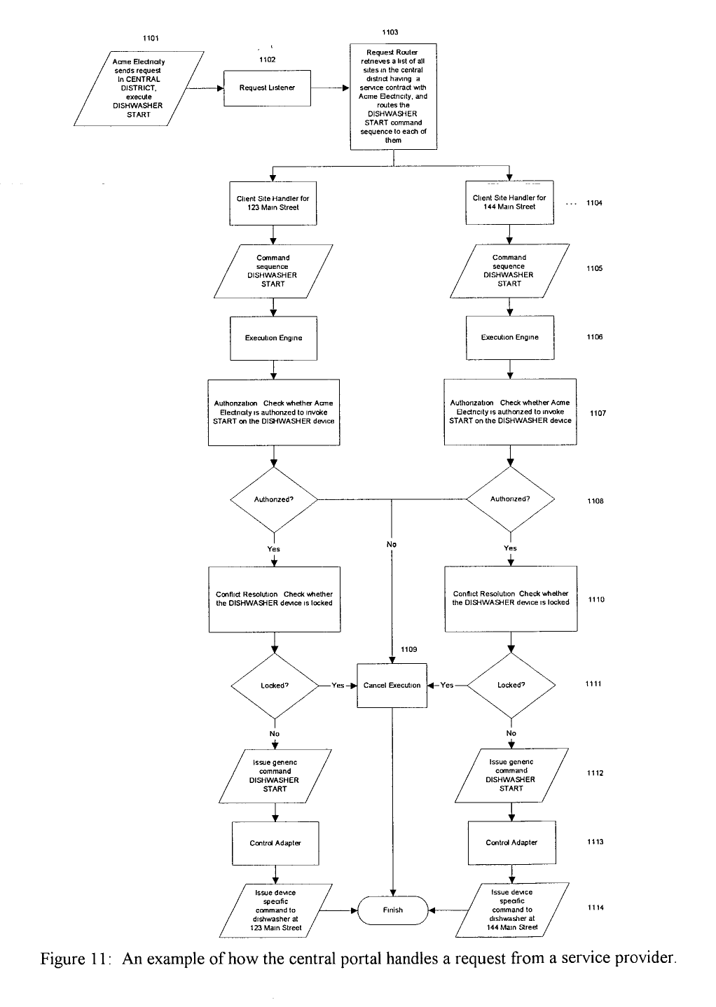

FIG. 11 shows an example of how an embodiment of the present invention handles a request from a service provider. In the example, the Acme Electricity Company is requesting the portal to start dishwashers at its Client Sites in the central district of the city (block 1101). The Request Listening mechanism within the portal receives the request (block 1102). It is then relayed through the Request Router mechanism (block 1103) which consults the list of Client Sites to obtain all Acme Electricity clients within the central district. This is done by issuing a query to the portal's data store. The request is then forwarded to a Client Site handler for each site in the result set (block 1104). The command sequences (block 1105) are relayed to an Execution Engine (block 1106), and each command is filtered by the Authorization mechanism (block 1107), which checks whether the command can be executed by Acme Electricity Company. Assuming that Acme is allowed to start dishwashers at each Client Site, the next step is a conflict check (block 1110) to see whether a lock exists on the dishwasher device. If there is no such lock, the commands are finally issued through a Control Adapter (blocks 1112 and 1113) to the participating devices at each site, over a wide-area network (block 1114). Failed authorization or conflict checks cause execution of the command to be cancelled (block 1109).

The device-specific commands generated from the original command sequence may vary for each Control Adapter and thereby for each Client Site. Embodiments of this invention may support mixed Control Adapters and Client Site control protocols on the same central portal, where some sites use for instance Universal Plug and Play protocols while others use OSGi, LonWorks or other protocols.

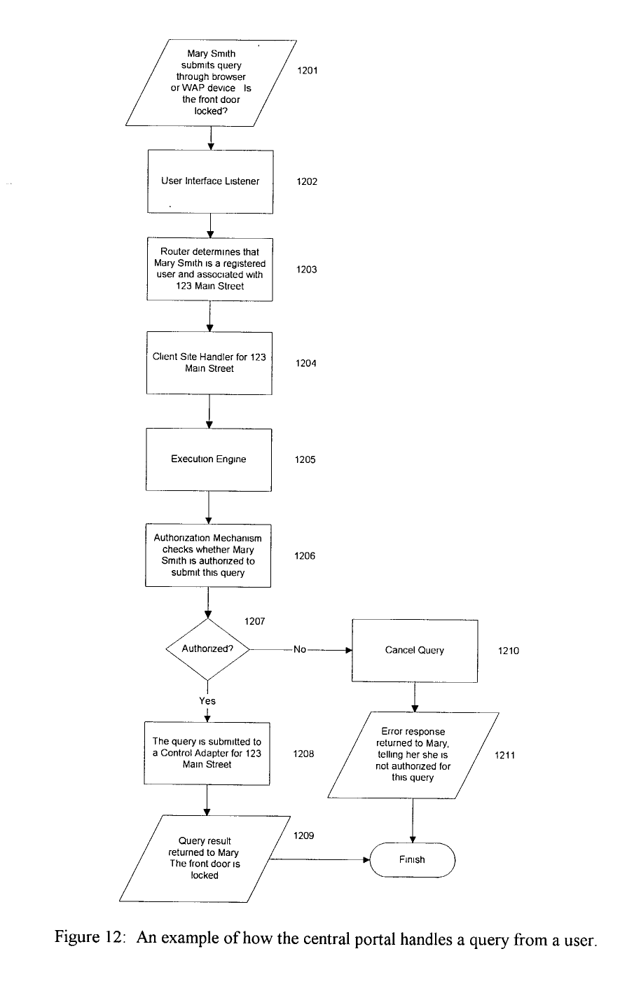

FIG. 12 shows an example of how the central portal handles a query from a user. In the example, Mary Smith is asking the portal whether the front door is locked at 123 Main Street (block 1201). The User Interface Listener within the portal receives the query (block 1202). It is then relayed through the Router mechanism (block 1203), after possible translation, to the Client Site handler for 123 Main Street (block 1204), since Mary Smith is registered as a user for that site. The Client Site handler passes the query to the Execution Engine (block 1205), which submits it to the Authorization mechanism (block 1206) to check whether Mary Smith is authorized to read the LOCKED property on the FRONT_DOOR device. Assuming that Mary is authorized, the query processor executes the query, sending a locking status query to a door sensor device at 123 Main Street through a Control Adapter (block 1208). Once the query result is ready, it is returned to Mary (block 1209).

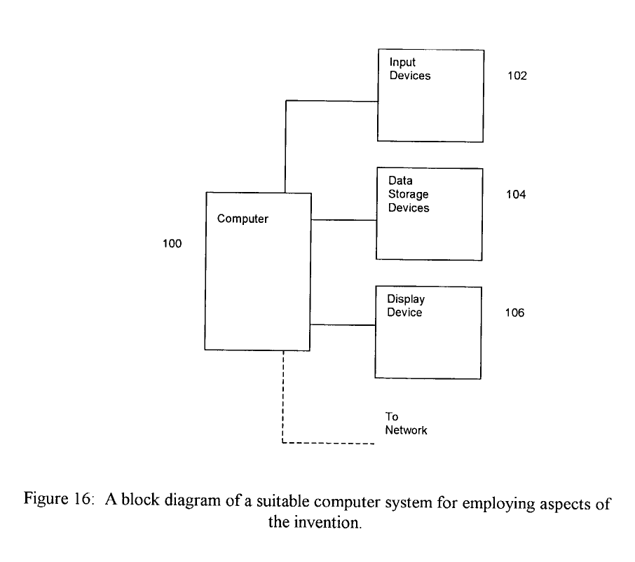

FIG. 16 and the discussion herein provide a brief, general description of a suitable computing environment in which aspects of the invention can be implemented. Although not required, aspects and embodiments of the invention are described in the general context of computer-executable instructions, such as routines executed by a general purpose computer, e.g., a server or personal computer. Those skilled in the relevant art will appreciate that aspects of the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

Aspects of the invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described herein may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention reside on a server computer, while corresponding portions reside on a client computer. Data structures and transmission of data particular to aspects of the invention are also encompassed within the scope of the invention.

Referring to FIG. 16, one embodiment of the invention employs a computer 100, such as a server or personal computer, coupled to one or more user input devices 102 and a data storage device 104, such as a hard disk drive or database. The computer is also coupled to output devices, including a display device 106.

The input devices 102 may include a keyboard and/or a pointing device such as a mouse. Other input devices are possible such as a microphone, joystick, game pad, scanner, and the like. The data storage device 104 may include any type of computer-readable media that can store data accessible by the computer 100, such as magnetic hard and floppy disk drives, Zip drives, optical disk drives, magnetic cassettes, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet (not shown in FIG. 16).

Aspects of the invention give homeowners and their families a simplified, central way to manage devices, appliances and services in their home. Once a home network and an Internet gateway are in place, it is straightforward to open up a network route or link between the gateway and the home portal and set up an account on the portal. This would normally be done by the system installer.

After an account is set up, a variety of pre-bundled home services can be selected and activated by pointing and clicking on the portal's Web site. These standard services can link together Internet content and home network control, for instance by selecting particular TV programs for viewing or recording, from a web-based TV guide, depending on whether family members are at home or not.

In the same vein, service providers can use the portal as a gateway to offer packaged services to homeowners and their families. By doing so, they avoid having to link up with individual home networks, which may use different control standards, such as Jini, OSGi and UPnP. Users are spared the inconvenience of maintaining individual log-in accounts with each service provider, and the security risk of punching further holes in their security firewalls.

The home portal server manages the set of services selected by users and provided by service providers, maintains a central schedule of events to be triggered periodically or at particular points in time, ensures that service providers only access the devices they are authorized to access, resolves priorities and mediates conflicts.

This solution is better than a point-to-point topology between home networks and service providers because of the following:

Homeowners do not need to maintain accounts with multiple service providers. Instead, they can use a central home portal account for all their home management needs.

Service providers do not need to link to and integrate with a multitude of home networks, possibly using different standards. Instead, they can talk to just one central mediator—the home portal. They also do not need to ask homeowners to open up their home network gateways to outside access.

The home portal allows bundling of services from multiple providers, as well as intertwining of Internet content and personal preferences, to tailor a unique environment for each home. It thus facilitates a compelling business model, where integrated, value-added bundles of services can be offered to consumers.

In general, while hardware platforms, such as clients and servers, are described herein, aspects of the invention are equally applicable to nodes on the network having corresponding resource locators to identify such nodes. One skilled in the relevant art will appreciate that the concepts of the invention can be used in various environments other than the Internet. Various communication channels, such as local area networks, wide area networks, or point-to-point dial-up connections, may be used instead of the Internet. Aspects of the system may be conducted within a single computer environment, rather than a client/server environment. Also, the user or client computers or hardware may comprise any combination of hardware or software that interacts with the server computer, such as television-based systems and various other consumer products through which commercial and noncommercial transactions can be conducted. The various aspects of the invention described herein can be implemented in or for any e-mail environment.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein” and “hereunder” and words of similar import, when used in this application, shall refer to this application as a whole and not to any particular portions of this application.

The above description of illustrated embodiments of the invention is not intended to be exhaustive or to limit the invention to the precise form disclosed. For example, in embodiments of this invention, queries can be expressed in different ways, for instance using an SQL-like syntax, XML representation, or other formats. While specific embodiments of, and examples for, the invention are described herein for illustrative purposes, various equivalent modifications are possible within the scope of the invention, as those skilled in the relevant art will recognize. For example, while steps of the various routines are presented in a given order, alternative embodiments may perform routines having steps in a different order. The teachings of the invention provided herein can be applied to other systems, not necessarily the system described above.

The various embodiments described above can be combined to provide further embodiments. All of the above references are incorporated herein by reference. Aspects of the invention can be modified, if necessary, to employ the systems, functions and concepts of the various references described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all media delivery systems that operate under the claims to provide a method for providing a central location to manage devices for numerous users at various Client Sites. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/we claim:

1. A computer-readable medium whose contents cause a server computer to control resources coupled to a network, comprising:
receiving an event associated with a client site;
identifying the client site from the received event and retrieving a stored record associated with the client site;
providing a command sequence based on the received event and the retrieved record; and
providing, over the network, an executable command sequence to a device residing at the client site to control the device at the client site.

2. The computer-readable medium of claim 1 wherein the network is the Internet, wherein receiving an event includes receiving an event from the client site and creating a generic internal format object based on the received event, and wherein identifying the client site includes routing the object to an event router.

3. The computer-readable medium of claim 1 wherein the computer-readable medium is a logical node in a computer network receiving the contents.

4. The computer-readable medium of claim 1 wherein the computer-readable medium is a computer-readable disk.

5. The computer-readable medium of claim 1 wherein the computer-readable medium is a data transmission medium transmitting a generated data signal containing the contents.

6. The computer-readable medium of claim 1 wherein the computer-readable medium is a memory of a computer system.

7. A method for controlling and coordinating access to devices and appliances, from a central portal server, comprising:
communicating with client site devices via a public communications network;
receiving event notifications from client site devices to the extent that the devices support such notifications;
querying the status of at least one of the client site devices;
receiving queries and requests for actions to be carried out at the client site, from a user over the public network;
receiving queries and requests for actions to be carried out at one or more client sites from one or more service providers over the public network;
obtaining notifications from a server system scheduling mechanism that a previously defined time has been reached; and
issuing commands to the client site devices based on the received queries and requests for actions from the user and service provider and the obtained notifications.
that are timely, not in conflict, consistent with authorization levels of the originating user or service provider, and that carry out the requested or pre-configured actions or queries at the client site.

8. The method of claim 7 wherein no scheduling, conflict resolution, prioritization or authorization mechanisms are required at the client site.

9. The method of claim 7 wherein issuing commands includes insuring authorization levels of the user or service provider are consistent with commands to be issued to the client site based on the received query.

10. The method of claim 7 wherein issuing commands includes resolving conflicts between queries and requests for actions received by the user and the service provider.

11. The method of claim 7 wherein issuing commands includes sending an electronic reply message to the user confirming issuance of a command based on the query and request received from the user.

12. A server system for controlling and coordinating users, service providers, client sites and devices comprising:
a data storage medium storing:
client site information for a plurality of client sites, including configuration information,
device information for a plurality of devices and their association with client sites;
user information for a plurality of users and their associations with client sites, including information for users' access rights and authorization levels;
service provider information for a plurality of service providers, their associations with client sites, including information for service providers' access rights and authorization levels;
a scheduling mechanism for triggering events to occur at predefined intervals or at predetermined points in time, for a plurality of client sites, and for routing the triggered events;
a client site listening mechanism for receiving event notifications from the client sites and routing the received client site event notifications;
a user interface mechanism for receiving configuration commands, queries and requests for actions from the plurality of users and routing the received configuration commands;
service provider listening mechanism for receiving requests for actions from the service providers and routing the received service provider requests; and
a client site handler mechanism that
receives incoming triggered events from the scheduling mechanism, event notifications from the client site listening mechanism, configuration commands from the user interface mechanism, and requests for actions from the service provider listening mechanism, and
issues a resulting sequence of commands to client site devices.

13. The server system of claim 12 wherein the server system is a portal server connected to multiple client sites.

14. The server system of claim 12 wherein the user interface mechanism receives requests from a browser for action from the plurality of users.

15. The server system of claim 12 wherein the client site devices and server system communicate with the server system through the Internet.

16. The server system of claim 12 wherein the client site devices communicate with a local gateway device, which then communicates with the server system through the Internet.

17. The server system of claim 12 wherein service providers communicate with the server system through the Internet.

18. The server system of claim 12, further comprising an authorization mechanism for ascertaining whether a particular user or service provider has required access rights and authorization level to cause a particular command sequence to be sent to a device at a client site based on information in the data storage medium.

19. The server system of claim 12 wherein the client site handler mechanism resolves conflicts between the incoming triggered events, event notifications, configuration commands and requests for actions.

20. The server system of claim 12 wherein the client site handler mechanism assigns priority to the incoming triggered events, event notifications, configuration commands and requests for actions, with respect to a particular client site.

21. The server system of claim 12 wherein the client site handler mechanism validates authorization based on the incoming triggered events, event notifications, configuration commands and requests for actions.

22. A method for interacting with a client site system over a public communications network, wherein the client site system includes at least one client site device coupled to the network, the method comprising:
providing, to a central portal over the network, a request to execute an event associated with the client site device wherein the request includes information identifying the client site from a plurality of client sites;
receiving a command sequence based on the request and client site identifying information, wherein the command sequence corresponds to the request and is formatted for the client site device; and
providing to the client site device the received command sequence to execute the requested event with respect to the client site device.
